(19) United States
(12) Patent Application Publication
(10) Pub. No.: US 2004/0061309 A1
(43) Pub. Date: Apr. 1, 2004

(54) Multi-axis hitch for trailers and implements

(76) Inventor: Gregory David Shoffner, Bend, OR (US)

Correspondence Address: GLENN C. BROWN, PC, 777 NW WALL STREET, SUITE 308, BEND, OR, 97701, US

(21) Appl. No.: 10/664,276

(22) Filed: Sep. 16, 2003

Related U.S. Application Data
(60) Provisional application No. 60/409,846, filed on Sep. 16, 2002.

(51) Int. Cl. B60D 1/00

(52) U.S. Cl. 280/494

(57) ABSTRACT

A three-axis hitch having a pair of yokes rotatably connected, each yoke connectable to a hitch member of a vehicle for joining the vehicles for towing, and wherein the vehicles' relative position can be varied in three axes.

### CROSS REFERENCE TO RELATED APPLICATION

This application is a continuation of U.S. serial No. 60/409,846, filed on Sep. 16, 2002. The priority of the prior application is expressly claimed and its disclosure is hereby incorporated by reference in its entirety.

### BACKGROUND OF THE INVENTION

This application is related to hitches used to temporarily couple a vehicle to a trailer, or in agricultural uses, a tractor to an implement. There are many instances in which one vehicle is used to tow another vehicle. The towed vehicle can be an agricultural implement, a piece of industrial equipment, a recreational vehicle of various sorts, or even a second auxiliary vehicle. It is often desirable to provide the maximum degree of relative movement between the two vehicles while at the same time maintaining a reliable coupling between the vehicles. In instances where the vehicles are used on other than public roads, the terrain can be steep and rugged, and one can encounter situations where the coupling between the vehicles is required to accommodate large angles between the vehicles in the vertical, horizontal and longitudinal axes.

Currently available trailer hitches can accommodate a certain amount of misalignment between the vehicles, but have their limits, beyond which the hitch and perhaps components on the vehicles are subjected to stresses and strains that can damage the hitch or one or both vehicles. There are a number of trailer hitch designs currently available, the most common being a ball hitch. A ball hitch includes a ball or rounded post attached to the vehicle. A cupped member is attached to the trailer, and includes a threaded clamping member that locks the cupped member onto the ball. A ball hitch provides relatively good angular displacement side to side, but provides relatively little vertical or rotational displacement.

A need therefore remains for a hitch that can accommodate increased angles of misalignment, and that can accommodate high degrees of misalignment in multiple axes simultaneously.

### SUMMARY OF THE INVENTION

This invention provides a hitch that in addition to wide lateral displacement, also provides very wide vertical and rotational displacement. In particular this invention is embodied in a hitch that rotates about three axes simultaneously, and which provides an unusually wide range of angular displacement between the vehicle and the trailer in each of the three axes individually and simultaneously.

The invention is embodied in a hitch that includes first and second yokes rotatably joined together. Each yoke includes a connector for pivotably receiving a hitch member mounted to a towing and a towed vehicle. The preferred embodiment provides essentially unlimited longitudinal rotation between the first and second yokes, and a large angle of displacement between the yokes and the hitch members attached to each vehicle, all simultaneously and in a manner that avoids transferring undue stresses and strains to either vehicle.

### BRIEF DESCRIPTION OF THE DRAWINGS

FIG. 1 is a side elevational view of a preferred embodiment of the invention.

FIG. 2 is a top elevational view of a preferred embodiment of the invention.

FIG. 3 is a perspective view of the embodiment of the invention shown in FIGS. 1 and 2.

### DETAILED DESCRIPTION OF THE PREFERRED EMBODIMENTS

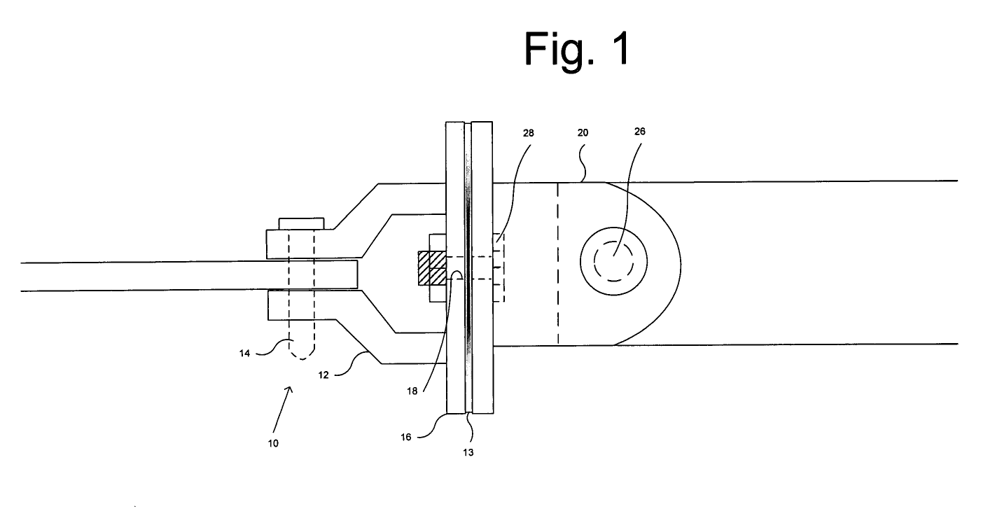

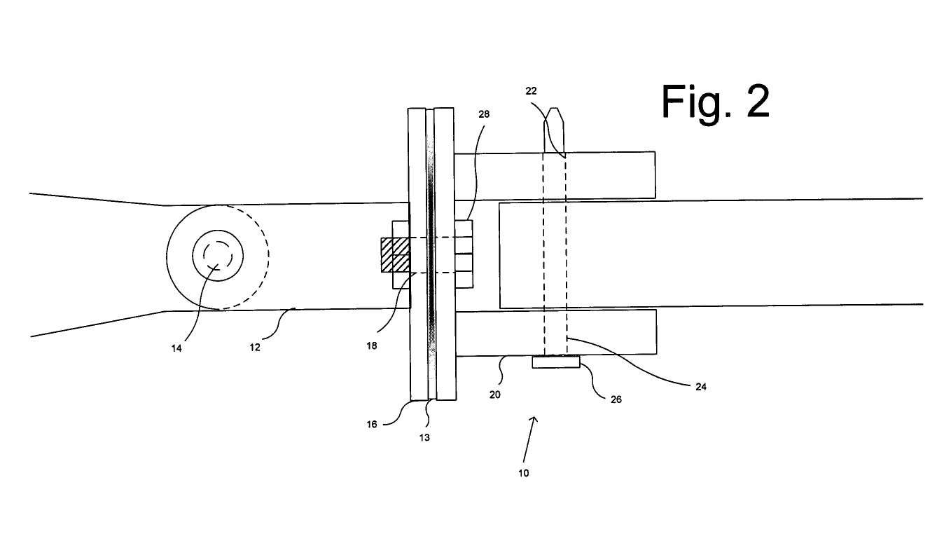

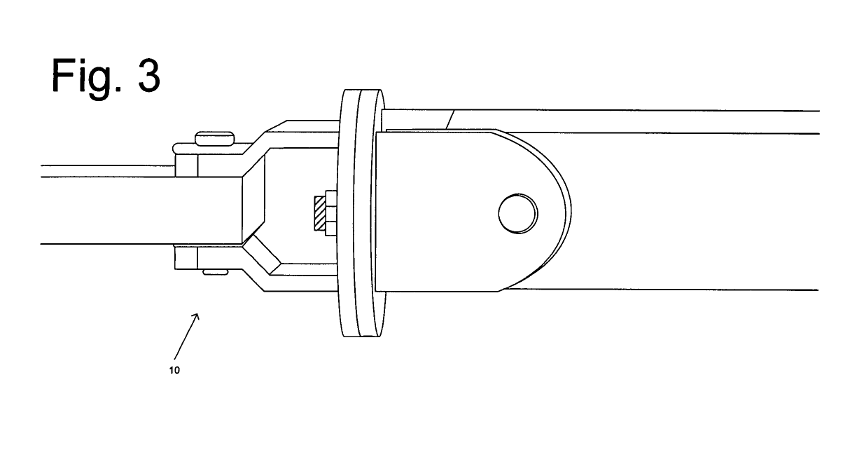

Referring now to FIGS. 1-3, a preferred embodiment of a hitch according to the invention is shown generally at 10. Hitch assembly 10 includes a first yoke 12 that is connected by a pin 14 to the trailer hitch provided on the vehicle (not shown). Yoke 12 includes an end plate 16 that includes an axial hole 18. Hitch assembly 10 includes a second yoke 20 that receives the trailer tongue. Yoke 20 includes a pair of holes 22 and 24 and a pin 26 that connect yoke 20 to the trailer tongue. Yokes 12 and 20 are connected by a pin or bolt 28 that permits relative rotation of yokes 12 and 20. In one preferred embodiment, a friction reducing washer 13 is inserted between yokes 12 and 20 to provide wear protection for the yokes and reduced rotational friction.

The hitch assembly 10 as described and shown provides large degrees of angular displacement and rotation between the vehicle and trailer, while at the same time being compact and reliable. The hitch assembly is preferably manufactured of high strength steel or other suitable metal, as are the bolts and pins used in the assembly. The hitch reliably transmits acceleration and braking forces between the vehicle and trailer.

While the invention has been described in reference to the illustrated preferred embodiments, the description is intended to illustrate the invention rather than to limit the invention. Those of skill in the art will recognize that numerous modifications in detail and arrangement are possible without departing from the scope of the following claims.

What is claimed is:

1. A three-axis vehicle hitch comprising:
a first yoke having a first base and a first pair of spaced apart arms extending perpendicularly from the base;
a second yoke having a second base and a second pair of spaced apart arms extending perpendicularly from the base;
the first and second bases pivotally attached for rotation around a first axis that is parallel to the first and second pairs of spaced apart arms;
the first pair of spaced apart arms having a connector adapted for pivotably receiving a rearwardly extending first hitch member of a first vehicle;
the second pair of spaced apart arms having a connector adapted for pivotably receiving a forwardly extending second hitch member of a second vehicle; and,
the first and second yokes operable to connect the first and second vehicles and to provide relative movement in three axes between the first and second vehicles.

2. A three-axis vehicle hitch according to claim 1 further comprising the first and second bases having respective first and second holes formed therethrough, and a first connector passing through the first and second holes to rotatably connect the first and second bases.

3. A three-axis vehicle hitch according to claim 2 wherein the first connector is selected from the group consisting of a bolt, a pin, and a washer.

4. A three-axis vehicle hitch according to claim 3 wherein the connector includes a bolt, a nut, and first and second washers.

5. A three-axis vehicle hitch according to claim 1 further comprising a washer between the first and second spacers.

6. A three-axis vehicle hitch according to claim 1 further comprising the first and second pairs of spaced apart arms each having coaxial transverse holes formed therein, and a retainer releasably mounted therein.

7. A three-axis vehicle hitch according to claim 2 further comprising the first and second pairs of spaced apart arms each having coaxial transverse holes formed therein, and a retainer releasably mounted therein.

8. A three-axis vehicle hitch according to claim 2 further comprising:
a rearwardly extending first hitch member of a first vehicle pivotably mounted in the first pair of spaced apart pair of arms; and,
a forwardly extending second hitch member of a second vehicle pivotably mounted in the second pair of spaced apart arms.

9. A three-axis vehicle hitch according to claim 1 further comprising the first and second bases rotatable at least 90 degrees relative to one another.

10. A three-axis vehicle hitch according to claim 1 further comprising the first and second bases rotatable at least 180 degrees relative to one another.

11. A three-axis vehicle hitch according to claim 1 further comprising the first and second bases rotatable at least 360 degrees relative to one another.

12. A three-axis vehicle hitch according to claim 8 further comprising the first and second hitch members pivotable at least 90 degrees relative to the respective first and second yokes.

13. A three-axis vehicle hitch according to claim 8 further comprising the first and second hitch members pivotable at least 180 degrees relative to the respective first and second yokes.

14. A three-axis vehicle hitch according to claim 8 further comprising the first and second hitch members pivotable at least 360 degrees relative to the respective first and second yokes.

15. A three-axis vehicle hitch comprising:
a first yoke having a first base and a first pair of spaced apart arms extending perpendicularly from the base;
a second yoke having a second base and a second pair of spaced apart arms extending perpendicularly from the base;
the first and second bases pivotally attached for rotation around a first axis that is parallel to the first and second pairs of spaced apart arms;
the first pair of spaced apart arms having a connector adapted for pivotably receiving a rearwardly extending first hitch member of a first vehicle;
the second pair of spaced apart arms having a connector adapted for pivotably receiving a forwardly extending second hitch member of a second vehicle;
the first and second yokes operable to connect the first and second vehicles and to provide relative movement in three axes between the first and second vehicles; and,
the first and second bases having respective first and second holes formed therethrough, and a first connector passing through the first and second holes to rotatably connect the first and second bases.
